(19) United States
(12) Patent Application Publication
(10) Pub. No.: US 2021/0264374 A1
(43) Pub. Date: Aug. 26, 2021

(54) TIME MONITORING SYSTEM

(71) Applicant: Tachyons Inc., Denver, CO (US)

(72) Inventors: Lam Ngoc Vo, Denver, CO (US); Sam Samad Attisha, La Mesa, CA (US)

(21) Appl. No.: 17/184,321

(22) Filed: Feb. 24, 2021

Related U.S. Application Data
(60) Provisional application No. 62/981,403, filed on Feb. 25, 2020.

(51) Int. Cl. G06Q 10/10; G06Q 10/06; G06K 9/00; G06N 20/00; H04W 4/12; G08B 5/22

(52) U.S. Cl. CPC G06Q 10/1091; G06Q 10/063114; G06K 9/00288; G08B 5/223; G06N 20/00; H04W 4/12; G06K 9/00228

(57) ABSTRACT

An employee time-monitoring system includes a computing device and a number of cameras in electrical communication with the computing device. The cameras may be installed at various locations of a workplace, e.g., at entrances and exits to the work facility, at employee workstations, and at breakrooms and at other common areas. In some embodiments, the computing device is configured to analyze data associated with photographs/videos recorded from the cameras in order to determine via facial recognition whether the data recorded from the cameras substantially matches data associated with a specific employee. In this manner, the employee time-monitoring system can automatically record a time of clock-in or clock-out of the employee that has been recognized via facial recognition. Advantageously, the system can automatically determine whether an employee is beginning a shift, ending a shift, visiting for nonwork related purposes, or taking a break, and can send the employee SMS break reminders.

### CROSS REFERENCE TO RELATED APPLICATIONS

This application claims priority to U.S. Provisional Patent Application Ser. No. 62/981,403, filed Feb. 25, 2020, the disclosure of which is incorporated by reference in its entirety.

### FIELD OF THE INVENTION

This invention relates generally to the field of employee time monitoring systems. More specifically, the present invention is directed in one exemplary aspect to a system that uses facial recognition to automatically log employee work and break time.

### BACKGROUND OF THE INVENTION

Time monitoring and productivity tracking in the workplace is crucial to maximizing the success of a business. Billions of dollars are lost every year by businesses which fail to keep accurate records of employee time. Additionally, billions of dollars are lost every year due to time theft. Methods used to commit time theft include such schemes as buddy punching, recording inaccurate time of presence/productivity, and employees using work time to engage in personal activities (e.g., personal phone calls, social media, socializing in the workplace, reading the news, etc.).

In addition to monetary losses associated with time theft and/or losses of employee productivity, lawsuits filed under the Fair Labor Standards Act (“FLSA”) are increasing every year, resulting in millions of dollars paid annually by employers in both settlements and judgments. FLSA lawsuits typically arise from a number of issues, such as employees failing to take breaks required by the state and/or federal regulations, employees eating lunch at their desks, and employers failing to be properly educated on FLSA regulations.

Conventional time-tracking systems require employees to manually clock-in and clock-out. These systems depend upon employee integrity and reliability. However, relying on employees has yielded a myriad of issues for businesses over the years, as at least one report has indicated that 80% of employee timesheets require correction, 44% of business owners struggle to diagnose and correct timesheet errors, and 34% of business owners have stated that their employees on various occasions have failed to properly clock in/out. This, in turn, has resulted not only in significant inconvenience and resource management issues associated with diagnosing and correcting such problems, but it has cut into business profitability, and has also exposed a number of businesses to liability under the FLSA as well.

What is needed is an automated time-monitoring system that does not require or rely on employees to track their own time. Ideally, the system would be able to automatically identify an employee by facial recognition after recording a photograph or a video containing an image of that employee. Preferably, the system would be able to identify facial features of a human using artificial intelligence, but without requiring the expensive, time-consuming process of feature engineering that is commonly associated with machine learning techniques. Preferably, the system would be able to automatically determine whether an employee is beginning a shift, ending a shift, taking a break, or merely visiting the work facilities for a nonwork related purpose. Preferably, the system would be able to determine employee break times according to applicable labor laws and regulations and automatically send break reminders to employees at appropriate times.

### SUMMARY OF THE INVENTION

Various embodiments of the present invention overcome the deficiencies of the prior art by providing an automated time-monitoring system that does not require employees to track their own time. In some embodiments, the system includes a set of one or more cameras disposed throughout the work facilities (e.g., at designated entrances, at designated exits, at individual workspaces, at common areas such as breakrooms, and/or at restricted areas), a computing device containing software for employee timekeeping and for facial recognition, and an employee database comprising employee data. The computing device can be configured to analyze data associated with photographs or videos recorded from the cameras in order to determine via facial recognition whether the data recorded from the cameras substantially matches data associated with a specific employee (e.g., as stored in the employee database). Once an employee has been identified via facial recognition, various embodiments of the present system can automatically determine whether that employee is beginning a shift, ending a shift, taking a break, or merely visiting the work facilities for nonwork related purposes, and then update that employee's work status accordingly. In this manner, compliance with local, state, and federal labor regulations can be ensured while requiring substantially less human intervention and oversight than as required by conventional systems.

In some embodiments, the system can automatically calculate an employee's break time and break duration based upon data associated with labor laws, an employee's clock-in time, and/or an employee's shift schedule. In some embodiments, the system can automatically send break reminders to employees at applicable times. The reminders may be transmitted in any number of ways, including without limitation: by e-mail, text messages, SMS, MMS, cellular, landline, or VoIP scheduled calls, and/or recorded audio/video reminders that are preinstalled or copied to an employee's associated computing device.

In some embodiments, a collection of videos associated with employee clock-ins and/or clock-outs may be stored within the computing device, the employee database, and/or in a remote device. These videos may be indexed, searched, and accessed by one or more end users (e.g., such as supervisors/administrators), or returned to an algorithm, function, command, or procedure upon request. The videos taken may be of a predetermined duration (e.g., 5 seconds), or they may be of a longer duration and subsequently shortened/cropped to have a predetermined duration in order to save storage space, for example.

In some embodiments, the system may be configured to identify human facial features via machine learning. By providing one or more input training models to the facial recognition software, the system can become progressively “better” at facial recognition as it gains progressively more experience with processing quality input data. In some embodiments, the system can be configured to identify human facial features via deep learning (a subset of machine learning), where the facial recognition software does not require the expensive, arduous, and time-consuming process of feature engineering in order to facilitate facial recognition.

Various embodiments of the present invention also present other advantages associated with data analysis. Timekeeping data gathered using the present system can enable employers to alter existing procedures/models and develop new business procedures/models based upon identified efficiencies. Additionally, employers can compare the percentage of shift clock-ins and clock-outs and miscellaneous clock-ins and clock-outs between ideal employees and non-ideal employees. For example, employers can compare miscellaneous clock-ins and clock-outs to determine which routes ideal employees use to maximize efficiency in getting to the restrooms, vending machines, meeting rooms, etc. After such data has been extensively studied and analyzed, employers can then use that data for training current and future employees. Additionally, such data can be used to assist in making necessary renovations or future construction to provide an environment most conducive to maximizing employee efficiency and, hence, productivity.

The foregoing and other features and advantages of embodiments of the invention will become apparent from the following, more particularized description of the preferred embodiments and corresponding figures.

### BRIEF DESCRIPTION OF THE DRAWINGS

For a more complete understanding of the present invention, the objects and advantages thereof, reference is now made to the ensuing descriptions taken in connection with the accompanying figures briefly described as follows:

FIG. 1 is a block diagram of an exemplary system of employee time monitoring according to various embodiments of the present invention.

FIG. 2 is a block diagram of an exemplary computing device for use in an employee time monitoring system according to various embodiments of the present invention.

FIG. 3 is a flow diagram of an exemplary process of automatically monitoring employee time according to various embodiments of the present invention.

FIG. 4 is a flow diagram of an exemplary process of automatically sending an SMS message to one or more employees according to various embodiments of the present invention.

### DETAILED DESCRIPTION OF THE PREFERRED EMBODIMENTS

Preferred embodiments of the present invention and their advantages may be understood by referring to the associated figures, wherein like reference numerals refer to like elements.

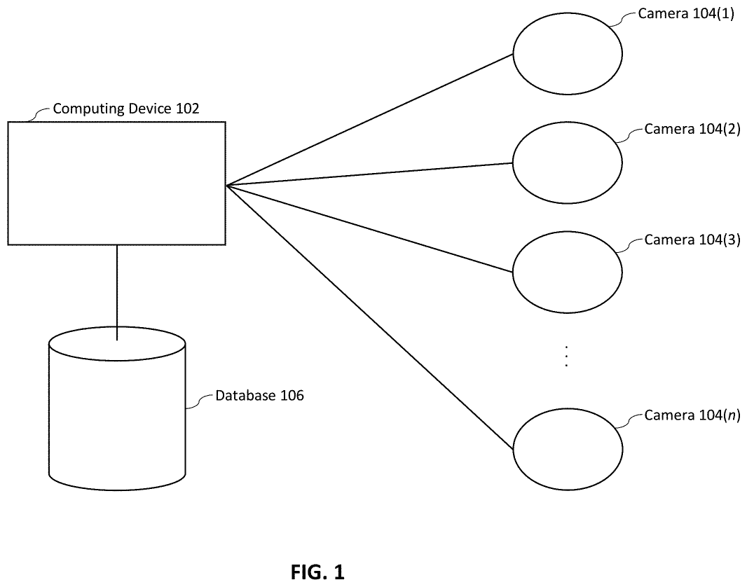

FIG. 1 is a block diagram of an exemplary system of employee time monitoring according to various embodiments of the present invention. As shown by the figure, computing device 102 may be in electrical communication with one or more cameras 104(1)-(n) that are installed at various locations of a worksite. The computing device 102 itself may also be located at the worksite, or it may be situated off-site at a remote location according to various embodiments.

Cameras 104 may be any type of device capable of recording a still image or a video, including without limitation mirrorless cameras, digital single lens reflex (DSLR) cameras, medium format cameras, compact/point-and-shoot cameras, closed-circuit television (CCTV) video/security cameras, IP cameras including those with real-time streaming processing capabilities, as well as additional devices employing a charged-coupled device (CCD) photodetector. The communicative links between computing device 102 and cameras 104 may be configured in a variety of ways, including without limitation point-to-point (P2), point-to-multipoint (P2MP), wired, or wireless configurations. The cameras 104 may be portable, stationary, moving, or rotatable cameras according to various embodiments. In preferred embodiments, cameras 104 are installed at specific locations at a worksite where employees must enter and exit the facilities. In some embodiments, cameras may be installed within employee workspaces, within common areas such as breakrooms, and optionally, within restricted areas as well. Installing cameras capable of facial recognition so as to monitor restricted areas can be used to identify and automatically report individuals who have made unauthorized entries into those restricted areas according to some embodiments.

Computing device 102 can be any electronic device capable of receiving data associated with a photograph, still image, screencap, video, or video frame recorded from one or more cameras 104, determining whether all or a portion of that data substantially matches one or more images of an employee already stored in an associated database 106, and then updating the identified employee's work status accordingly (e.g., clocked-in or clocked out for a work shift, clocked-in or clocked out for a paid or unpaid break, or clocked-in or clocked-out for a non-work related purpose). In this manner, employee work time and break time can be automatically tracked and monitored. Computing device 102 can be a server, desktop, laptop/notebook, tablet, console, smart phone, other smart device, or combination thereof according to various embodiments.

Database 106 can be a collection of data associated with current (and optionally past) employees of a business entity or other organization. Database 106 can be one or more combination of databases including, without limitation, a centralized database, a distributed database, a relational or SQL database, a non-relational/NoSQL database, an object-oriented database, a cloud database, a columnar or wide-columnar database, and/or a key-value database according to various embodiments. In some embodiments, database 106 includes image data associated with each employee (e.g., a photograph, still image, screencap, video frame, video, etc.). Textual descriptors of an employee may be stored in addition to, or in lieu of, employee image data. In some embodiments, database 106 can be a separate system that is accessible remotely by computing device 102 (such as shown in FIG. 1), while in other embodiments, database 106 can be entirely or partially disposed within the computing device 102 itself

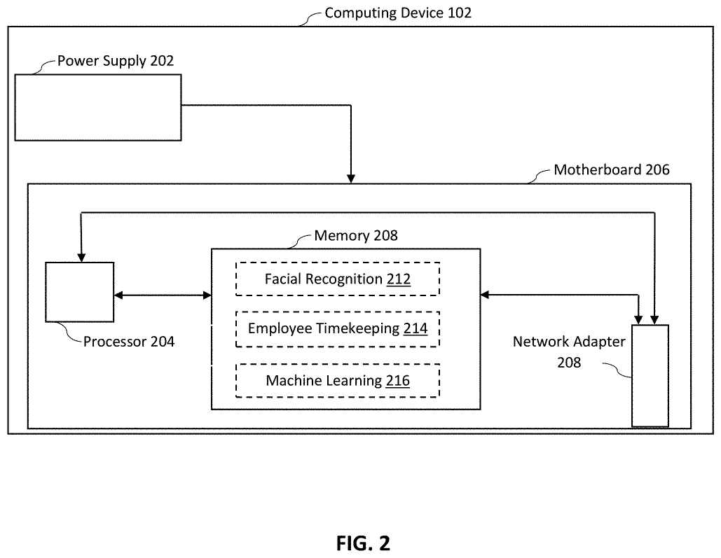

FIG. 2 is a block diagram of an exemplary computing device for use in an employee time monitoring system according to various embodiments of the present invention. As shown by the figure, computing device 102 can include a power supply 202, one or more processors 204, a motherboard 206, a network adapter 208, as well as memory 210 containing sets of instructions/software modules for facial recognition 212, employee timekeeping 214, and machine learning 216 (each shown in dashed lines within the memory 210).

A power supply 202 provides a source of power to the various components disposed within computing device 102. In some embodiments, power is supplied externally via one or more conductive wires, for example, from a power cable or serial bus cable. In other embodiments, one or more batteries may be used as a source of power.

One or more processors 204 disposed upon motherboard 206 are adapted to execute sequences of instructions by loading and storing data to memory 210. The one or more processors 204 may utilize a variety of clock-speeds and/or bit architectures, can be single-core or multi-core, special purpose, RISC, CISC, or other types of processors according to various embodiments. Distributed processing may be used in lieu of, or in addition to, centralized processing according to various embodiments.

Network adapter 208 includes any type of hardware device or module disposed within or otherwise connected to computing device 102 that is adapted to communicatively interface with one or more external devices or external modules. In some embodiments, network adapter 208 facilitates communication between the computing device 102 and the one or more cameras 104 (see FIG. 1 and accompanying text); in some embodiments, network adapter 208 facilitates communication between the computing device 102 and an external database 106 (see FIG. 1 and accompanying text). The network adapter 208 may accommodate any wired or wireless protocol including, without limitation, USB, FireWire, Ethernet, Gigabit Ethernet, MoCA, radio frequency tuners, modems, WiFi, Blutooth, WiMax, and/or Infrared Data Association according to various embodiments.

Memory 210 can be any type of module adapted to enable digital information to be stored, retained, and retrieved. Additionally, memory 210 may be any combination of volatile and non-volatile storage devices, including without limitation RAM, DRAM, SRAM, ROM, and/or flash memory. Note also that the memory 210 may be organized in any number of architectural configurations utilizing, for example, combinations of registers, cache memory, data buffers, main memory, virtual memory, mass storage, and/or removable media.

Software resident within memory 210 may include a set of instructions for facial recognition 212 according to various embodiments. In some embodiments, the facial recognition software 212 may be configured to determine whether facial data associated with an input photograph, still image, screencap, video frame, or video (as taken from cameras 104; see FIG. 1 and accompanying text) substantially matches facial data associated with a specific employee (e.g., as stored in database 106). In some embodiments, the match determination may be based upon a comparative analysis of multiple photographs, still images, screencaps, video frames, or videos. One or more similarity thresholds may be used for the purpose of identifying substantial matches according to various embodiments. In some embodiments, received image data may also include associated time information (such as a timestamp) so as to indicate the time that image data was recorded by the one or more cameras 104; in other embodiments, the facial recognition software 212 may associate timing data with received image data using the system clock of the computing device 102 itself. Once a match has been identified, the system may display information such as an employee's full name, job title, employee ID, and social network link. In some embodiments, the facial recognition software 212 may be configured to tag or highlight multiple individuals identified in the image data, and optionally, to generate a composite image.

Software resident within memory 210 may include a set of instructions for employee timekeeping 214 according to various embodiments. The employee timekeeping software 214 may keep track of employee clock-ins and clock-outs based upon an analysis of any combination of variables, including, without limitation: an employee's current location, an employee's current work status, an employee's current shift schedule, an employee's current break time, break duration, or break schedule, and recorded times/timestamps associated with data recorded from cameras 104. In some embodiments, the employee timekeeping software 214 can determine whether an employee is beginning or ending a shift, beginning or ending a break, or entering/exiting the work facilities for nonwork-related reasons based upon an analysis of these variables.

In some embodiments, the employee timekeeping software 214 can automatically calculate employee break times based upon a set of input data that may include, without limitation, the beginning of an employee's shift and/or an employee's determined clock-in time, as well as data associated with applicable labor laws (for example, that all non-exempt employees must receive a 10 minute paid break after working 3.5 consecutive hours; that both exempt and non-exempt employees must receive a 30 minute unpaid break after working at least 5 hours, etc.). In preferred embodiments, the data associated with applicable labor laws is editable since labor laws can change over time or businesses might otherwise relocate to a different region.

According to some embodiments, if an employee leaves his/her workspace after clocking-in for a shift, a designated workspace camera can capture an image of the employee, and this image can be subsequently analyzed by the facial recognition software in order to determine the identity of the employee. Likewise, upon the employee's return to the workspace, the designated workspace camera can capture a second image of the employee which can also be analyzed by the facial recognition software to determine the identity of the employee. In some embodiments, in addition to identifying the employee leaving his work area, the software can also predict if the employee is taking a break based on an analysis of one or more of the aforementioned variables. For example, if the employee has already been clocked-in and is absent from his work area for more than a predetermined period of time, such as 10 minutes, then the absence can be characterized as a break and the corresponding video instances recorded and saved as a break clock-out and clock-in, respectively. If the employee is absent for less than a predetermined period, then the video instances may be saved and flagged in a system-generated report (e.g., a daily and/or weekly report), such that supervisory personnel can extract and review these video instances, in conjunction with video instances taken from other areas in the work facilities during this same period of absence, in order to verify and/or determine the purpose of the employee's absence. If necessary, according to some embodiments, manual adjustments can be made to the employee's time via a user interface such as a dashboard. In some embodiments, break periods may be aggregated at the conclusion of each day, i.e., at the time of the employee's final clock-out.

In some embodiments, the employee timekeeping software 214 may be further configured to automatically send messages to designated supervisory personnel, or to employees themselves at predetermined intervals or upon the condition of specific occurrences. The messages can include, for example, reminders that it is time for an one or more employees to take a break, task messages regarding a specific project that a supervisor wishes a specific employee or group of employees to complete, and/or work information such as the employee's total hours worked and the actual or estimated hours for those earnings. The frequency, type, content, and timing of such messages can be specified by a system administrator or supervisor through a system interface such as a dashboard, for example. The messages may be transmitted in any number of ways, including without limitation: by e-mail, text messages, SMS, MMS, cellular, landline, or VoIP scheduled calls, and/or recorded audio/video content that is preinstalled or copied to an employee's associated computing device. Some messages may require the message recipient to acknowledge receipt of the message according to various embodiments.

In some embodiments, the software can calculate break times based on shift duration in accordance with local, state, and federal regulations. For example, if such regulations require a 30-minute lunch break and two 10-minute lunch breaks during the course of an 8 hour shift, the software can automatically calculate employee break times based upon the shift clock-in time and/or the employee's actual clock-in time, and notify each employee when it is time to take each break. Once the employee has been prompted that it is time to take a break, the employee can then exit toward the assigned clock-out camera (e.g., a designated workspace camera) and the camera can then capture an image of the employee. The image can then be analyzed by the facial recognition software 212 in order to determine the identity of the employee. After the identity is determined, the system can record a lunch or break clock-out and then store the corresponding video-instance in memory. Likewise, upon the employee's return to his/her workspace, the assigned clock-in camera (e.g., a designated workspace camera) can capture a second image of the employee which is then analyzed by the facial recognition software to determine the identity of the employee. After the employee's identity is determined, the system can record a lunch or break clock-in and then store the corresponding video-instance in memory.

In some embodiments, the system can generate red-flag alerts upon detecting the occurrence of certain conditions. For example, if an employee has clocked-in but has not clocked-out after working 10 hours, an SMS and/or an e-mail can be sent to both the employee and his/her supervisor. As a second example, if an employee is consistently late to work (e.g., his shift begins promptly at 8:00 a.m. but he has clocked in at 8:07 a.m. for three consecutive days) then the system can automatically send a reminder/warning to that employee. If the employee's tardiness continues, an alert/notice such as an SMS or e-mail can then be automatically sent to his supervisor informing the supervisor about the employee's repeated infractions.

In some embodiments, the system can automatically generate an employee's timesheet report. The timesheet report can consist of, for example, the employee's total hours worked, their total break minutes including the frequency of their breaks with links to specific clock-in and clock-out video instances, and their total non-work minutes including their non-work event frequency with links to specific clock-in and clock-out video instances. The system can automatically record and export this information into a report at a pre-set interval (e.g., daily, weekly, bi-weekly, and/or monthly). In some embodiments, the timesheet can be exported to Microsoft Excel and integrated with major payroll systems such as ADP and PayChex.

Returning now to FIG. 2, the software resident within memory 210 may also include a set of instructions for machine learning 216 according to some embodiments. Machine learning is a type of artificial intelligence (AI) where a computing system is able to improve its ability to make decisions through experience. Typically, a set of input sample data, or “training data” is first fed to a machine learning algorithm. For example, if the algorithm was programmed to determine whether a person in a given picture had blonde hair, the training data may include pictures of persons known to have blonde hair, as well as pictures of persons known not to have blonde hair. By repeatedly analyzing patterns or characteristics in the data, the more quality data that is analyzed and processed by the machine learning algorithm, the “better” the algorithm will eventually become at performing its programmed task, e.g., determining whether a person in a given picture has blonde hair.

Historically, machine learning algorithms have struggled with processing soft data such as images, video, sound files, and unstructured text. When a machine learning algorithm struggles to identify patterns appearing in the data, often an expensive, time-consuming, and arduous process known as “feature engineering” must be employed in order to facilitate pattern recognition by the machine learning algorithm. Special instructions may be hardcoded or otherwise provided as input to the machine-learning algorithm in order to assist it with pattern recognition.

Some embodiments of the present invention therefore utilize a deep learning algorithm to circumvent these issues. Deep learning is a subset of machine learning where the artificial intelligence algorithm can identify patterns in data without requiring the arduous, time-consuming process of featuring engineering. Deep learning is a class of machine learning algorithms which uses multiple layers to progressively extract higher level features from raw input. For example, in image processing, lower layers may identify edges, while higher layers may identify the concepts relevant to a human such as digits, letters, or faces.

In deep learning, each level may learn to transform its input data into a slightly more abstract and composite representation. In an image recognition application, for example, the raw input may be a matrix of pixels, whereby the first representational layer may abstract the pixels and encode edges, the second layer may compose and encode arrangements of edges, the third layer may encode a nose and eyes, and the fourth layer may recognize that the image contains a face. Importantly, a deep learning process, through artificial intelligence, can autonomously learn which features to optimally place in which level. Deep learning can be implemented using neural networks according to some embodiments.

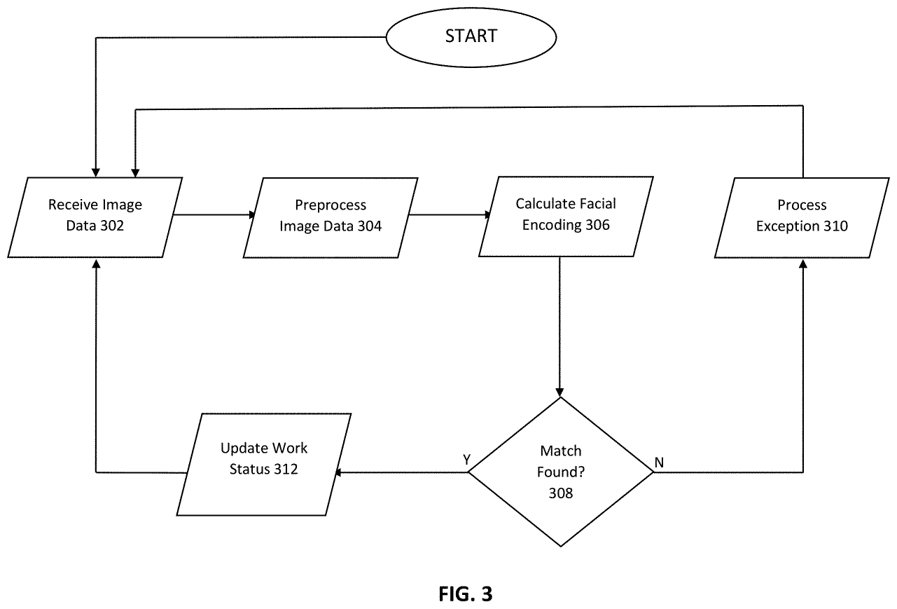

FIG. 3 is a flow diagram of an exemplary process of automatically monitoring employee time according to various embodiments of the present invention. In this manner, the system can automatically clock-in or clock-out an employee based upon facial recognition.

At block 302, data associated with one or more photographs, still images, screencaps, video frames, and/or videos that have been captured by one or more cameras is received at a computing device. The data may be received via hardwire or wirelessly. Further, the data may be received from a network adapter according to some embodiments, or it may be written directly into memory according to other embodiments.

At block 304, the received data may be preprocessed in order to prepare it for facial recognition. For example, according to some embodiments, the one or more photographs, still images, screencaps, video frames, or videos may be initially cropped in order to identify a facial region and thereby eliminate extraneous data. Other preprocessing steps may include, without limitation: gray scale transformation and pixel brightness transformation (such as gamma correction), image contrast enhancement (such as histogram equalization), and geometric/positional transformations according to various embodiments.

At block 306, a facial encoding may be calculated from the input facial data. The facial encoding may contain a set of data which facilitates comparative matching to facial encodings already indexed, stored, or generated from one or more employee databases according to some embodiments. The facial encoding may be stored and optionally indexed in a file, data structure, object, or block of memory according to some embodiments.

At decision block 308, the facial encoding may be iteratively compared to specific facial encodings associated with an employee. In some embodiments, the comparison immediately returns a result upon discovering a match with calculated similarity equaling or exceeding a predetermined threshold. In other embodiments, the facial encoding is compared to the facial encoding of each employee, and the “best” match (i.e. the match having the highest calculated level of similarity) may be returned.

In some embodiments, if no match has been discovered after iterating through the facial encodings of all employees, then at block 310, an exception may be processed in any number of ways. For example, an error may be written to a log, an alert may be generated to indicate that an unauthorized individual may be present at the work facilities, and/or a manual identification of the individual appearing in a still image may be requested by the system. According to some embodiments, a system administrator can specify how the system should behave in these circumstances.

In some embodiments, exceptions may also be signaled when a certain event was expected to occur (such as a clock-in at the beginning of an employee's shift), but did not occur at all, did not occur within an expected time range, or did not occur prior another event happening (such as a clock-out of the same employee). In the event of an undefined clock-in/clock-out occurrence, the system may record the employee's absence and categorize it as an undefined absence. Any camera data associated with the triggering of the exception can optionally be stored and subsequently retrieved by a system administrator according to some embodiments. Such undefined absences can be flagged on a report intended for the employee's supervisor, and the supervisor can subsequently decide how treat the undefined absences according to their own discretion.

On the other hand, if a match has been discovered, the employee's work status can then be updated at block 312 and the process may then resume at block 302. As already stated above, in some embodiments, the system can advantageously determine whether the employee is beginning a shift, ending a shift, taking a break, or visiting the work-facilities for a non-work related purpose by analyzing a set of variables, including without limitation an employee's current location (as determined, for example, by which camera that employee's image recently appeared in), an employee's current work status, an employee's current shift schedule, an employee's current break time, break duration, or break schedule, and a recorded time/timestamp associated with data recorded from the cameras.

In some embodiments, the detected absence of an individual at a certain location (as determined by a detected lack of data shown in still images taken by one or more cameras) and/or at certain times can be used to facilitate updating an employee's work status according to various embodiments. For example, if a designated camera is positioned at an employee's workstation, and the system cannot identify any individual being present in a still image recorded by that camera at a certain time, that information may be one of the data points analyzed in order to determine whether the employee has ended a shift or has taken a break. In some embodiments, this information can be further used to determine whether an employee has taken days off of work (e.g., sick days or vacation days), and/or to dock employees who are not at their workstation at required times.

In some embodiments, at predetermined intervals (e.g., daily, weekly, bi-weekly, etc.), the computing device can generate a log or a report that details each employee's clock-in/clock-out times, as well as the duration of the time of all breaks taken by a corresponding employee. The system can automatically calculate each employee's hours of productivity based on the period of time between that employee's clock-in times and the clock-out times, minus aggregated break periods that were taken by that employee throughout the workday. In some embodiments, the time calculated can be adjusted based on various circumstances. For example, if it is determined that an employee's absence from his/her workspace constituted an unauthorized break, the time of that absence can be deducted from the employee's calculated time, and/or as part of a non-working hours total.

In some embodiments, a collection of image data (such as photographs or videos) associated with employee clock-ins and/or clock-outs may be stored within the computing device, the employee database, and/or in a remote device. These videos may be indexed, searched, and accessed by one or more authorized end users (e.g., such as a supervisor/administrator), or otherwise returned to a calling algorithm, function, command, or procedure upon request. The videos taken may be of a predetermined duration (e.g., 5 seconds), or they may be of a longer duration and subsequently shortened/cropped to have a predetermined duration in order to save storage space, for example. The image data may be accessed and filtered based upon input search criteria, such as the identification (e.g., the employee ID number or name) of a particular employee, job title, location, the unique camera identifier of the camera which was used to record the image data, and/or the date/time that the image data was recorded.

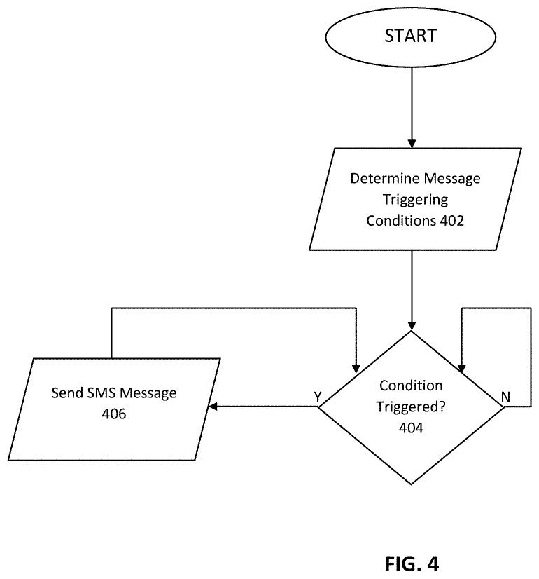

FIG. 4 is a flow diagram of an exemplary process of automatically sending an SMS message to one or more employees according to various embodiments of the present invention.

At block 402, the system determines a set of message triggering conditions. According to some embodiments, such conditions may be triggered upon the occurrence of one or more events, such as an employee initially clocking-in on a Tuesday. Conditions may also be triggered upon the lack of occurrence of a certain event, such as an employee failing to clock-out for lunch, or the employee failing to clock-in by the beginning of a scheduled shift for three days in a given work cycle. In other scenarios, a message may be scheduled to occur on a specific date/time or regularly at predetermined dates/times, such as at the beginning of every employee's lunch break on Mondays-Wednesdays during the first two weeks of August. A supervisor or system administrator can schedule such messages through a user interface such as a dashboard, for example, and can further specify the content, type, duration, and intended recipients of the message. Aside from scheduled messages, immediate, emergency, or unscheduled messages can also be sent according to various embodiments.

At block 404, the system determines whether a set of triggering conditions for a given message have all been satisfied. If every condition has been satisfied, the corresponding message may then be transmitted at block 406. Although an SMS message is indicated at block 406, as already mentioned above, the messages may be transmitted in any number of ways, including without limitation: by e-mail, text messages, SMS, MMS, cellular, landline, or VoIP scheduled calls, and/or recorded audio/video reminders that are preinstalled or copied to an employee's associated computing device. The process then repeats at block 404.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. An electronic time-monitoring system comprising:
a. a computing device comprising:
i. memory comprising a set of instructions for facial recognition, and a set of instructions for employee timekeeping; and
ii. a processor adapted to execute instructions stored in the memory;
b. an employee database in electrical communication with the computing device, the employee database comprising employee data; and
c. one or more cameras in electrical communication with the computing device, wherein each of said one or more cameras is configured to record camera data;
wherein the computing device is configured to update an employee's work status upon identifying an employee by facial recognition, and wherein said identifying an employee by facial recognition is based at least in part upon analyzing camera data and employee data.

2. The system of claim 1, wherein the set of instructions for facial recognition is configured to identify facial features based at least in part upon analyzing data from an input training model.

3. The system of claim 2, wherein the set of instructions for facial recognition is configured to identify facial features based at least in part upon a machine learning algorithm.

4. The system of claim 2, wherein the set of instructions for facial recognition is configured to identify facial features based at least in part upon a deep learning algorithm.

5. The system of claim 2, wherein the set of instructions for facial recognition is configured to identify facial features without the use of feature engineering.

6. The system of claim 1, wherein the employee data comprises a still image. The system of claim 1, wherein the camera data comprises a photograph.

8. The system of claim 1, wherein the camera data comprises a video.

9. The system of claim 8, wherein the computing device is further configured to enable videos of predetermined length that are associated with employee clock-ins and clock-outs to be searched and accessed by an end-user.

10. The system of claim 1, wherein updating an employee's work status further comprises clocking-in an employee upon determining that employee is entering work.

11. The system of claim 1, wherein updating an employee's work status further comprises clocking-out an employee upon determining that employee is exiting work.

12. The system of claim 1, wherein updating an employee's work status further comprises determining if an employee is taking a break.

13. The system of claim 1, wherein the set of instructions for employee timekeeping comprises accessing an employee shift schedule.

14. The system of claim 13, wherein the set of instructions for employee timekeeping is configured to determine whether an employee is beginning a shift, resuming work after a break, or entering the facilities for an unscheduled visit based at least in part upon the employee shift schedule.

15. The system of claim 13, wherein the set of instructions for employee timekeeping is configured to determine whether an employee is ending a shift, beginning a break, or exiting the facilities after an unscheduled visit based at least in part upon the employee shift schedule.

16. The system of claim 13, wherein the memory further comprises a set of instructions configured to determine employee break times.

17. The system of claim 16, wherein determining employee break times is based at least in part upon data associated with labor laws and recorded clock-in times.

18. The system of claim 16, wherein the memory further comprises a set of instructions configured to indicate that it is a break time for a designated employee.

19. The system of claim 18, wherein the memory further comprises a set of instructions configured to transmit a break time reminder to the designated employee.

20. The system of claim 19, wherein the break time reminder comprises an SMS message.
